(19) United States
(12) Patent Application Publication
(10) Pub. No.: US 2006/0170653 A1
(43) Pub. Date: Aug. 3, 2006

(54) Pointing device with switch

(75) Inventor: Ronald S. Cok, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/048,094

(22) Filed: Feb. 1, 2005

(51) Int. Cl. G09G 5/08

(52) U.S. Cl. 345/157

(57) ABSTRACT

A system for controlling location of a pointing icon in a graphic user interface on a display, comprises: a movable element; means to detect the motion of the element; a controller responsive to the motion of the element to change the location of the pointing icon in the graphic user interface; one or more switch(e)s for changing the focus of the graphic user interface; and one or more additional switch(es) for changing location of the pointing icon on the display without changing the focus of the graphic user interface.

### FIELD OF THE INVENTION

The present invention relates to a system for controlling location of a pointing icon in a graphic user interface on a display, and more particularly, to such systems employing pointing devices with an additional switch(es) for controlling pointing icon movements particularly useful for wide-screen displays.

### BACKGROUND OF THE INVENTION

Information display device devices are well known and used for a wide variety of applications for which information, and user interaction with information, are critical. Monitors associated with computers are a typical and widely used example. A typical monitor has an aspect ratio of approximately 4:3 and is slightly wider than it is high when viewed by a user seated or standing in front of the monitor. Many modem computers are capable of driving such monitors at a variety of pixel resolutions, for example 800 by 600, 1280 by 1024, 1600 by 1200 and 1920 by 1200.

Given the plethora of information presented to users of computing devices, it is important that the displays be efficiently used so as to present as much useful information as possible while maintaining clarity and ease of use when interacting with the presented information. The conventional computer interface today is a graphic user interface or GUI. A variety of devices are used to interact with information presented on a display in a graphic user interface, for example, keyboards and pointing devices such as a computer mouse, trackball, and tablet. Typically, such devices employ position sensing circuitry to detect the motion of an object, for example the motion of a mouse, a ball in a trackball, a joy-stick, and a finger or light-pen on a tablet. The motion detected is translated into motion of a cursor on a display controlled by a computer and responsive to the pointing device. Pointing devices such as a mouse or trackball usually also include switches, typically depressible buttons, incorporated in the body of the pointing device that indicate desired actions in an application by a user. Such actions may include selecting text from a text window, selecting graphic elements such as buttons to indicate the desired performance of the action associated with the graphic element, and selecting text input fields in a graphic interface for the input of text. Sophisticated pointing devices also incorporate other capabilities. For example, US20040212587 A1 entitled “Computer input device with angular displacement detection capabilities” discloses a mouse that includes one or more sensor systems for detecting translational displacement and angular displacement of the input device relative to a support surface. The input device transmits a signal to a computing device in response to detecting the translational displacement and angular displacement, and the computing device moves an image on a display screen in a linear manner in response to the signal. The sensor system within the input device may be an optical sensor system, for example. Other pointing devices include inertial sensing. For example, U.S. Pat. No. 6,621,483 B2 entitled “Optical screen pointing device with inertial properties” describes an apparatus for controlling the position of a screen pointer for an electronic device having a display screen that includes an imaging surface against which a portion of the tip of a human digit may be placed. A light source illuminates that portion of the tip of the digit that is placed against the imaging surface, thereby generating reflected images. The apparatus includes a motion transducer. A lens receives the reflected images and directs the reflected images onto the motion transducer. The motion transducer generates digital representations of the reflected images. The motion transducer generates a first set of movement data based on the digital representations of the reflected images. The first set of movement data is indicative of motion of the tip of the digit across the imaging surface. A controller generates a second set of movement data when the tip of the human digit is removed from the imaging surface. The second set of movement data is indicative of motion of the tip of the digit across the imaging surface prior to removal of the tip. Various wired and wireless pointing devices are also known, for example, US20030165342 A1 entitled “Device for controlling a computer system” describes mouse-type pointing devices without wired connections and using infrared radiation.

Devices employing force feedback are also known and providing a variable mapping of device motion to cursor motion on a screen. For example US20020033799 A1 entitled “Enhanced cursor control using interface devices” describes a force feedback interface device including a manipulandum, such as a mouse that is moveable in a local workspace. The device is coupled to a host computer that displays a cursor in a graphical environment, such as a GUI, on a display screen. An interior region and a border region in the local workspace is defined. One mapping of device movement to cursor movement is used for the interior region, and a different mapping is used for the border region. Mapping methods include ballistics, absolute, linear, rate control, and variable absolute. Rate control embodiments can be single axis or dual axis. In one embodiment, when the mouse moves from the interior region to the border region, the mapping providing the greater cursor velocity is used to better conserve device workspace in the direction of travel and to decrease any sense of mapping mode change to the user. Other features include an autocentering function for reducing offset between local and host frames.

Special cursor movements can be employed with specific applications to enhance productivity within the application. For example, U.S. Pat. No. 5,510,811 A entitled “Apparatus and method for controlling cursor movement” describes an apparatus and method for navigating through an application program on a computer coupled to a computer-controlled display screen. The user can control the cursor position on the computer-controlled display using simple controls. The invention may use a hand-held controller with a four-direction control button and a function select button. The computer accepts the direction input information and moves the cursor or focus according to one of three different navigation functions. The first two navigation functions are selected by the application program, and may change from one navigation to another in different portions of the program or under user control. With the first navigation function, the direction buttons on the controller shift the focus from one hot spot to another hot spot in the selected direction using predefined criteria. With the second navigation function, the focus is shifted from a present position on the computer-controlled display to the adjacent position in the selected direction. If the function select button is depressed while the focus is on a hot spot, the function associated with that particular hot spot are enabled. A third navigation function is enabled if the function select button and the directional control button are both depressed. With the third navigational function, the focus moves from the current position in any direction selected by the directional control button. The focus movement may simultaneously occur in two dimensions using any of the navigational functions if the user selects directions in two dimensions on the four directional control button. However, such methods are limited to specific applications and may require specialized mouse controls.

Other cursor control methods intended to enhance the productivity of a user are known. Such techniques often rely upon an analysis of mouse movement to anticipate the intended position of a cursor and then move the cursor to that intended location. In some methods, the intended locations are an underlying grid of points. In other methods, existing icons or windows in a display are the goal. Some techniques provide short-cuts for moving a cursor from one location to another. For example, U.S. Pat. No. 5,367,631 A entitled “Cursor control device with programmable preset cursor positions” describes a method and apparatus for instantaneously and discontinuously moving the cursor in a computer system to any one of a plurality of user-selected screen positions is disclosed. In a first preferred embodiment, X- and Y-axis position sensing means are incorporated into the mouse's known electronics. A program correlates a plurality of X- and Y-axis mouse positions with a plurality of cursor positions on the display. When the computer user moves the cursor control device into any one of these programmed positions, the cursor on the display automatically moves to the predetermined position. In addition, less extreme motion of the mouse will result in a rate of cursor movement across the screen which increases linearly with the degree of tilt, up to the point where a predefined threshold is reached, at which time the cursor automatically and discontinuously jumps to the user's predefined screen location (s). However, these methods suffer from usability concerns in that an error in anticipating a user's intent is annoying to the user or additional movement to re-position a cursor involves tedious hand motion that decreases overall usability.

While these pointing devices are useful in optimizing the interaction of a user with a windowed user interface for information presentation and application control, the information that can be presented is limited by the resolution of the display on which the information and applications are presented. By expanding the resolution and size of an interactive display, increased screen space may be provided. For example, US20040239890 A1 entitled “Curved-screen immersive rear projection display” describes an immersive rear projection display capable of providing aspect ratios of 2.66:1 or 4:1, or even greater. This allows viewers to be “immersed” in the images being displayed because the images can encompass both the direct and the peripheral views of a viewer. In one implementation, the immersive rear projection display includes two or more electronic projectors (e.g., three) that are positioned behind a curved translucent display screen. The electronic projectors project respective display images adjacent each other onto the display screen. Regardless of the technology employed to present information in a wide screen format (i.e., width to height aspect ratio greater than 4:3), this approach can provide additional horizontal resolution in a monitor that can be employed to display additional information.

It is also known and practiced to provide a windowed user interface for the presentation of information and the use of a pointing device such as a mouse, trackball, or tablet to interact with the information. The interfaces can include for example icons, interactive graphical elements such as buttons and menus. Textual information (for example, text document, spreadsheet documents, and presentation documents) is conventionally presented in a pane within a window and multiple views of a single text file may be provided. The textual information may also include graphical elements such as graphs, images, and the like. However, these prior-art windowed graphic user interfaces and pointing devices are not optimized to the efficient use and navigation within a wide-screen display. In particular, moving a pointing device, such as a cursor controlled by a mouse or trackball, is tedious because of the extent of the screen. If a user is employing a position-sensitive mouse, the mouse may need to be lifted up and relocated on a pad or desktop to move the cursor a large distance over a screen. Likewise, a trackball may need to be rotated several times or spun with control to move a large distance. If the pointing devices are set to move large distances with less motion of the pointing device, the accuracy of positioning the pointing device with respect to the information presented on a screen may become difficult.

There is a need therefore for an improved general-purpose pointing device in a graphic user interface for information presentation and interaction on a wide-screen display.

### SUMMARY OF THE INVENTION

In accordance with one embodiment, the invention is directed towards a system for controlling location of a pointing icon in a graphic user interface on a display, comprises: a movable element; means to detect the motion of the element; a controller responsive to the motion of the element to change the location of the pointing icon in the graphic user interface; one or more switch(es) for changing the focus of the graphic user interface; and one or more additional switch(es) for changing location of the pointing icon on the display without changing the focus of the graphic user interface.

The present invention is also directed to a method for controlling location of a pointing icon in a graphic user interface on a display, comprising: providing pointing device having a movable element, means to detect the motion of the element, a controller responsive to the motion of the element to change the location of the pointing icon in the graphic user interface, one or more switch(es) for changing the focus of the graphic user interface, and one or more additional switch(es) for changing location of the pointing icon on the display without changing the focus of the graphic user interface; positioning the pointing icon in the graphic user interface on the display; and actuating one or more of the additional switch(es) to move the pointing icon in the graphic user interface on the display.

### ADVANTAGES

The present invention has the advantage that it provides improved efficiency for user interaction with data in a display, particularly in displays with a wide-screen format.

### BRIEF DESCRIPTION OF THE DRAWINGS

FIG. 1 is a perspective view of a pointing device according to one embodiment of the present invention;

FIG. 2 is a schematic depiction of a computer system employing the present invention; and

FIGS. 3a-3d are illustrations of pointing icon movements useful in understanding the present invention.

### DETAILED DESCRIPTION OF THE INVENTION

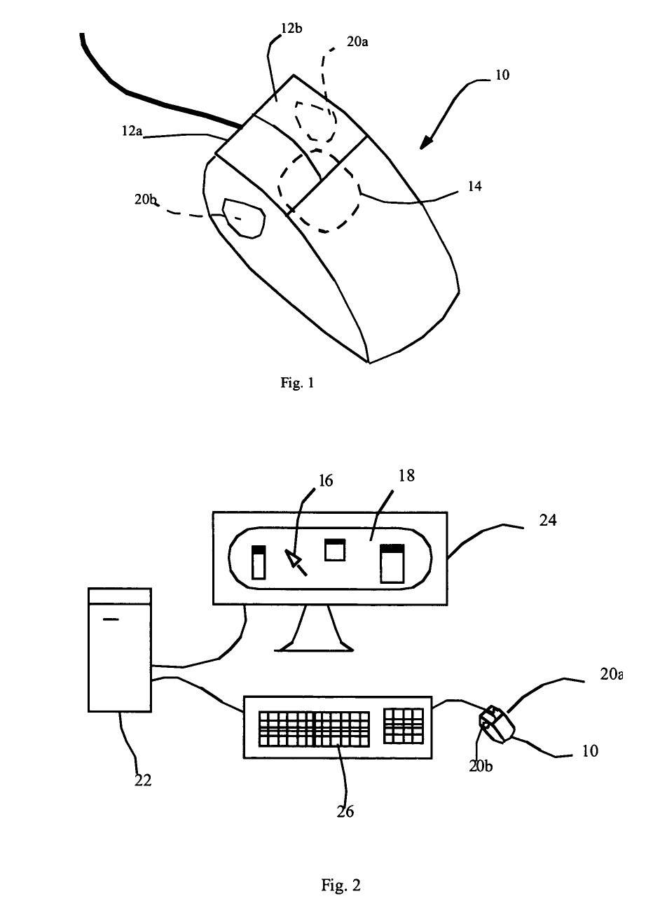

Referring to FIGS. 1 and 2, a system for controlling location of a pointing icon 16 in a graphic user interface 18 on a display 24, comprises: a movable element 10; means 14 to detect the motion of the movable element 10; a controller 22 responsive to the motion of the movable element 10 to change the location of the pointing icon 16 in the graphic user interface 18; one or more switch(es) 12a and 12b for changing the focus of the graphic user interface 18; and one or more additional switch(es) 20a and 20b for changing location of the pointing icon 16 on the display 24 without changing the focus of the graphic user interface 18.

As used herein, a pointing icon is a graphic representation of a position in a graphic user interface that is controlled by a pointing device, for example, a computer-controlled mouse. The term cursor can mean the graphic pointing icon element, for example an arrow as shown in FIG. 2. Alternatively, the term cursor can refer to a graphic element representing an insertion point in a document, for example a vertical bar, a blinking underline, or a rectangle, as may be found in applications for text editing. The pointing icon may change shape to indicate the nature of the graphic user interface application or contents over which the pointing icon is located. For example, in some graphic user interfaces, an arrow is generally employed over graphic controls or a screen area while an “I bar” is employed over text information. The present invention is directed toward an apparatus and method for the movement of a pointing icon in a graphic user interface and is not addressed to the movement of an insertion point in a document.

In a typical graphic user interface computing environment, a multiplicity of software applications may be available and may be open, that is a copy of the application and any documents associated with the application are resident in the memory of the computer. However, only one application at a time has the graphic user interface focus, that is any keystrokes on a keyboard or other interface device action will interact with the application having the focus. Typically, by using keyboard keystrokes or by operating switches on a pointing device, the focus may be changed from one application to another, as well as to different locations within a single application. The present invention is directed toward an apparatus and method for the movement of a pointing icon in a graphic user interface without changing the focus of the graphic user interface. In particular, the present invention is intended to only change the location of the pointing icon in the graphic user interface without changing other attributes or state of the graphic user interface. The ability to change the location of a pointing icon in a graphic user interface rapidly over large areas without changing focus enables a user to more readily navigate in a wide screen display without interfering with or confusing a user's interaction with the active application. The present invention simply facilitates pointing icon movement in a wide screen display.

Pointing devices can include a variety of products, for example a computer mouse, joystick, pen and tablet, or trackball device. Other pointing devices are known using other technologies, for example inertial devices, and are included in the present invention. For a pointing device such as a mouse, the movable element is the mouse itself. The means 14 for detecting motion in a mouse may include a rotary or optical element for detecting mouse movement over a surface. In other pointing devices such as a trackball, the movable element may be a rotatable ball itself which is typically incorporated into a stationary housing. Means 14 in such case may be one or more sensors positioned in the housing for detecting rotation of the trackball. Alternatively, pointing devices such as tablets may employ a stationary element (a tablet) with a movable element (a pen) that moves in relationship to the stationary element. In some pointing devices, it is preferred to employ a single interaction switch (for example a one-button mouse) or two interaction switches 12a and 12b (for example a two-button mouse) for interacting with the graphic user interface and changing the focus. The interaction switches 12a and 12b may be conventional actuators known and practiced in the prior art. For example, the interaction switches may serve to signal a controlling computer to change the graphic interface focus, to locate or move a cursor to change the insertion point within a document, to select icons for actions or text editing or other operations such as operating a pull down menu, and to select portions of displayed information (e.g., drawing selection rectangles) or graphic elements. Other interactive controls may also be employed, for example rotary switches that change the location of information on a screen without changing focus or position of a pointing icon. Various pointing devices with interaction switches, movable elements, and other controls are commercially available.

The controller 22 may be a conventional computer or microprocessor as is known in the art. The controller 22 interacts with the pointing device 10 and either directly controls the graphic user interface and the location of the pointing icon 16 or interacts with another computing device to control the location of the pointing icon 16.

The additional switches 20a, 20b of the present invention for changing location of the pointing icon on the display without changing the focus of the graphic user interface may be depressible buttons or another switching mechanism known in the art. For example, the additional switch(es) may be depressible buttons similar to the switches 12a and 12b. The switches may provide a single on-off signal or may provide a continuous status signal. It is also possible to provide an additional switch by combining use of a conventional interaction switch 12a, 12b with the activation of a key on a keyboard 26, for example by pressing a key and then operating a switch 12a, 12b.

Referring to FIG. 2, the pointing device 10 of the present invention may be employed in a computer system including controller 22 (in this case a computer), a wide-screen display 24, and a keyboard 26. The computer responds to the pointing device 10 and controls a display 24 and pointing icon 16 in response to location changes and switch actuations of the pointing device 10.

In one embodiment of the present invention, a plurality of additional switches for changing location of the pointing icon on the display without changing the focus of the graphic user interface may be employed. For example, first and second additional switches may be employed, wherein the first additional switch is located to the left of the second additional switch and when actuated moves the pointing icon to the left, and the second additional switch is located to the right of the first additional switch and when actuated moves the pointing icon to the right. In response to the operation of these additional switches, the controller 22 moves the pointing icon 16 across the display 24. Preferably, two additional switches 20a and 20b are employed on the left and right sides of the pointing device of the present invention. If the left additional switch 20b is actuated, the controller 22 responds to the switch actuation by moving the pointing icon 16 to the left. If the right additional switch 20a is actuated, the controller 22 responds to the additional switch 20a actuation by moving the pointing icon 16 to the right.

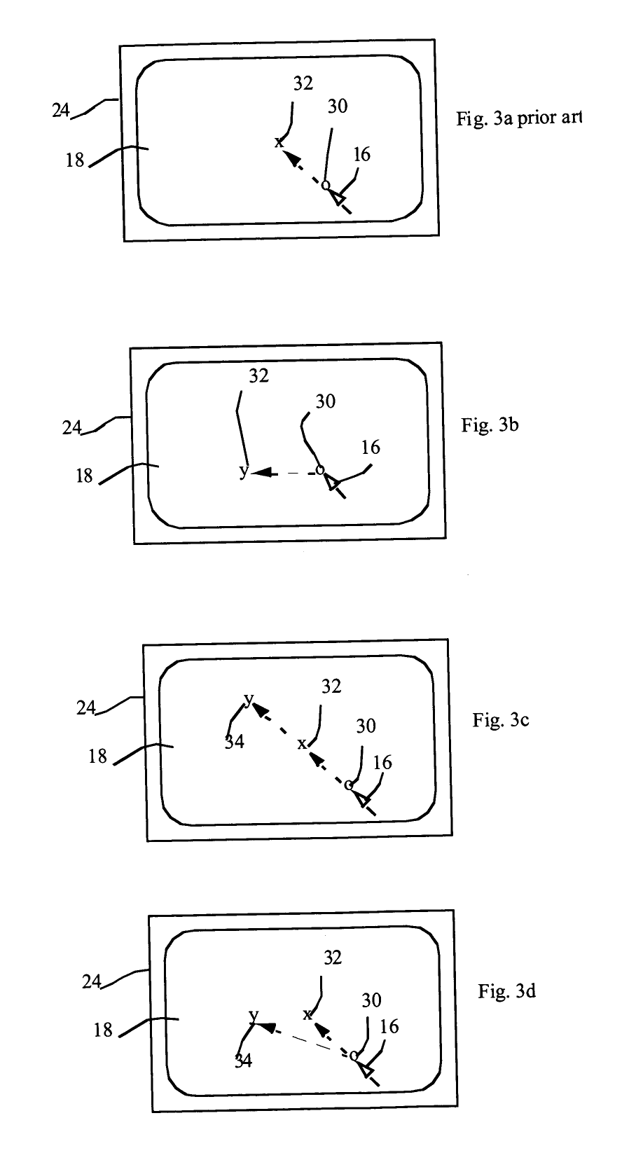

Referring to FIGS. 3a-3d, a variety of pointing icon motions are possible in response to actuation of an additional switch. In a typical conventional prior-art implementation, the movement of a pointing device to the left and away from a user results in a motion of the pointing icon to the left and upward in a graphic user interface 18 on a display 24 (e.g., from position “o” 30 to position “x” 32). In one embodiment of the present invention, the operation of an additional switch 20a, 20b moves a pointing icon a fixed fraction of the screen width to the left or right, depending on which position switch is operated.

The fraction may be selected by a user as a preference. As shown in FIG. 3b, activation of the additional switch 20b moves the pointing icon 16 to the left to position “y” 34. Preferably, actuating the left additional switch 20b will move the pointing icon to the left of whatever location the pointing icon is initially at. Likewise, actuating the right additional switch 20a will move the pointing icon to the right of whatever location the pointing icon is initially at.

In one embodiment, the additional switches may provide a single on-off signal and move the pointing icon discontinuously, such that the pointing icon “jumps” across the screen. The amount that the pointing icon moves may be a fixed number of pixels, a fraction of the screen width, or a fraction of the distance from the initial location of the pointing icon in the graphic user interface to the edge of the user interface. Alternatively, the additional switch may provide a continuous signal (for example by commencing an action upon the depression of a switch and completing the action by releasing the switch). If a continuous signal is employed, the pointing icon may be moved continuously to the left or right (depending on which switch is actuateid). While the switch is depressed, the pointing icon continues to move; a user simply holds the additional switch down until the pointing icon is at or near the location desired. Upon release of the switch, the pointing icon stops moving. A choice of continuous or discontinuous movement and the nature and speed of the movement may be adjustable by a user, for example by setting preferences.

In an alternative embodiment of the present invention, a plurality of pointing icons may be employed in a graphic user interface. In this embodiment, only one pointing icon at a time may be active, such that any interaction with the graphic user interface and information shown on the graphic user interface is done with reference to the location of the active pointing icon. Operating an additional switch may sequentially activate each pointing icon, signaling the controller to change the location of the active pointing icon from one to another of the plurality of pointing icons. Alternatively, each pointing icon may be associated with a position switch. For example, two pointing icons may be employed, a left pointing icon associated with a left additional switch (e.g. 20b) and a right pointing icon, associated with a right additional switch (e.g. 20a). By operating an additional switch the corresponding associated pointing icon is made active and represents the location of the pointing icon in the graphic user interface. Movement of the pointing device may only effect the location of the active pointing icon, such that upon reactivation, a pointing icon will be activated in its last active position. .

The additional switches may be used in combination with movement of the movable element of the pointing device 10. For example, while the pointing device is moving an additional switch may be actuated simultaneously to exaggerate the movement of the pointing icon. The net change in location of the pointing icon can be a combination of these actions. For example, referring to FIG. 3c, a motion of the pointing device that would have resulted in the movement of the pointing icon 16 from point “o” 30 to point “x” 32 is accelerated or exaggerated and the pointing icon moves a greater amount in the direction indicated by the movement of the pointing device to location “y” 34. Alternatively, motion in the horizontal direction only may be accelerated or exaggerated. Referring to FIG. 3d, for example, motion of the pointing device that would have resulted in the movement of the pointing icon 16 from point “o” 30 to point “x” 32 is accelerated or exaggerated in the horizontal direction only and the pointing icon moves a greater amount in the same horizontal direction indicated by the movement of the pointing device to location “y” 34, while moving the same vertical distance that would have resulted from movement of the pointing device without activation of the additional switch.

In accordance with preferred embodiments, the present invention may be most usefully employed with flat or curved wide-screen displays. As used herein, any display with an aspect ratio greater than 4:3 is considered a wide-screen display. Wide-screen monitors may include a display device with a curved rigid substrate that is employed together with the present invention as a component within an otherwise conventional desktop computer. In a further embodiment of the present invention, a curved panoramic display monitor may be employed, that is one that has at least a 16:9 ratio between width and height and subtends at least 45 degrees when viewed at a normal viewing distance.

The present invention may be employed as a method for controlling location of a pointing icon in a graphic user interface on a display, comprising the steps of: providing a pointing device having a movable element, means to detect the motion of the element, a controller responsive to the motion of the element to change the location of the pointing icon in the graphic user interface, one or more switch(es) for changing the focus of the graphic user interface, and one or more additional switch(es) for changing location of the pointing icon on the display without changing the focus of the graphic user interface; positioning the pointing icon in the graphic user interface on the display; and actuating one or more of the additional switch(es) to move the pointing icon in the graphic user interface on the display.

The present invention is improved over the prior art as it enables taking advantage of a wide-screen display while overcoming difficulties inherent in using such a wide-screen display. For example, a large screen enables a greater amount of information to be displayed. In such a large wide-screen display, pointing icon movements over large areas become tedious. For example if a pointing device such as a mouse or track-ball is employed to move a pointing icon across a wide screen, the pointing device must be moved a relatively large distance or the control of the pointing device be made very coarse. Neither approach provides a useful solution. By providing a pointing device with additional switches to move a pointing icon position from one location in a display screen to another, user efficiency in interacting with information displayed on a wide screen may be improved.

A variety of technologies may be employed to implement a wide-screen display, with or without a curved substrate, useful in combination with the present invention. In one embodiment, the present invention is employed with a display device that includes Organic Light Emitting Diodes (OLEDs) which are composed of small molecule or polymeric OLEDs as disclosed in but not limited to U.S. Pat. No. 4,769,292, issued Sep. 6, 1988 to Tang et al., and U.S. Pat. No. 5,061,569, issued Oct. 29, 1991 to VanSlyke et al. Many combinations and variations of organic light emitting displays can be used to fabricate such a device.

The invention has been described in detail with particular reference to certain preferred embodiments thereof, but it will be understood that variations and modifications can be effected within the spirit and scope of the invention.

### PARTS LIST

10 pointing device
12a, 12b switches
14 movement sensor
16 pointing icon
18 graphic user interface
20a, 20b additional switches
22 controller
wide-screen display
26 keyboard
30 initial pointing icon location
32 modified pointing icon location
34 modified pointing icon location

1. A system for controlling location of a pointing icon in a graphic user interface on a display, comprising:
a) a movable element;
b) means to detect the motion of the element;
c) a controller responsive to the motion of the element to change the location of the pointing icon in the graphic user interface;
d) one or more switch(e)s for changing the focus of the graphic user interface; and
e) one or more additional switch(es) for changing location of the pointing icon on the display without changing the focus of the graphic user interface.

2. The system of claim 1, further comprising a keyboard and wherein the additional switch(es) comprises at least one keyboard key.

3. The system of claim 1 wherein the movable element is a component of a computer mouse, joystick, pen and tablet, or trackball device.

4. The system of claim 3 wherein the one or more additional switch(es) comprise depressible button(s) on the computer mouse, joystick, pen and tablet, or trackball device.

5. The system of claim 1 wherein operation of the additional switch moves the pointing icon horizontally.

6. The system of claim 5 wherein first and second additional switches are employed, the first additional switch is located to the left of the second additional switch and moves the pointing icon to the left and the second additional switch is located to the right of the first additional switch and moves the pointing icon to the right.

7. The system of claim 1 wherein operation of the additional switch moves the pointing icon continuously.

8. The system of claim 1 wherein operation of the additional switch moves the pointing icon discontinuously a predetermined distance in the graphic user interface.

9. The system of claim 1 wherein the change in location of the pointing icon is in response to both the operation of the additional switch and movement of the movable element.

10. The system of claim 9 wherein the change in location of the pointing icon is accelerated in response to the operation of the additional switch and in the direction indicated by the movement of the movable element.

11. The system of claim 9 wherein the change in location of the pointing icon cursor is accelerated in the horizontal direction in response to the operation of the additional switch indicated by the movement of the movable element.

12. The system of claim 1, further comprising a plurality of independent pointing icons, one of which is active at any given moment, and wherein the controller sequentially activates each pointing icon when the additional switch is actuated.

13. The system of claim 1, further comprising a plurality of independent pointing icons, each pointing icon is associated with an additional switch, wherein one pointing icon is active at any given moment, and the controller activates each pointing icon when its associated additional switch is actuated.

14. The system of claim 1, wherein the display comprises a widescreen display.

15. A method for controlling location of a pointing icon in a graphic user interface on a display, comprising:
a) providing pointing device having a movable element, means to detect the motion of the element, a controller responsive to the motion of the element to change the location of the pointing icon in the graphic user interface, one or more switch(e)s for changing the focus of the graphic user interface, and one or more additional switch(es) for changing location of the pointing icon on the display without changing the focus of the graphic user interface;
b) positioning the pointing icon in the graphic user interface on the display; and
c) actuating one or more of the additional switch(es) to move the pointing icon in the graphic user interface on the display.
